(19) United States
(12) Patent Application Publication
(10) Pub. No.: US 2025/0265112 A1
(43) Pub. Date: Aug. 21, 2025

(54) INFORMATION PROCESSING APPARATUS, INFORMATION PROCESSING METHOD, AND NON-TRANSITORY RECORDING MEDIUM

(71) Applicant: Daiki Sakurada, KANAGAWA (JP)

(72) Inventor: Daiki Sakurada, KANAGAWA (JP)

(73) Assignee: Ricoh Company, Ltd., Tokyo (JP)

(21) Appl. No.: 18/977,003

(22) Filed: Dec. 11, 2024

(30) Foreign Application Priority Data
Feb. 20, 2024 (JP) 2024-024041

(51) Int. Cl. G06F 9/48; G06F 8/65

(52) U.S. Cl. CPC G06F 9/485; G06F 8/65

(57) ABSTRACT

An information processing apparatus includes circuitry and a memory that includes first and second storage areas. The first storage area includes multiple firmware storage partitions each storing firmware and multiple application storage partitions each storing an application. The firmware is executed at startup of the apparatus. The second storage area stores flag information including information of which one of the firmware storage partitions is to be selected to start the firmware. The circuitry executes first and second activators. The first activator starts the firmware stored in one of the firmware storage partitions based on the flag information. After the first activator starts the firmware stored in the one of the firmware storage partitions, the second activator starts the application stored in one of the application storage partitions based on the flag information. The one of the application storage partitions is associated with the one of the firmware storage partitions.

### CROSS-REFERENCE TO RELATED APPLICATIONS

This patent application is based on and claims priority pursuant to 35 U.S.C. § 119(a) to Japanese Patent Application No. 2024-024041, filed on Feb. 20, 2024, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

A related-art information processing apparatus recovers from a situation in which a system of the information processing apparatus fails to start due to damage to firmware. For example, the information processing apparatus includes, in a flash read only memory (ROM), a plurality of blocks storing basic input/output system (BIOS) data and rewrites the BIOS data in a block different from a block used in the startup of the system.

### SUMMARY

In one embodiment, there is provided an information processing apparatus that includes, for example, a memory and circuitry. The memory includes a first storage area and a second storage area. The first storage area includes a plurality of firmware storage partitions each storing firmware and a plurality of application storage partitions each storing an application. The firmware is executed at startup of the information processing apparatus. The second storage area stores flag information including information of which one of the plurality of firmware storage partitions is to be selected to start the firmware. The circuitry executes a first activator and a second activator. The first activator starts the firmware stored in one of the plurality of firmware storage partitions based on the flag information. After the first activator starts the firmware stored in the one of the plurality of firmware storage partitions, the second activator starts the application stored in one of the plurality of application storage partitions based on the flag information. The one of the plurality of application storage partitions is associated with the one of the plurality of firmware storage partitions.

In one embodiment, there is provided an information processing method performed by an information processing apparatus that includes a memory including a first storage area and a second storage area. The first storage area includes a plurality of firmware storage partitions each storing firmware and a plurality of application storage partitions each storing an application. The firmware is executed at startup of the information processing apparatus. The second storage area stores flag information including information of which one of the plurality of firmware storage partitions is to be selected to start the firmware. The information processing method includes, for example, starting the firmware stored in one of the plurality of firmware storage partitions based on the flag information, and after starting the firmware stored in the one of the plurality of firmware storage partitions, starting the application stored in one of the plurality of application storage partitions based on the flag information. The one of the plurality of application storage partitions is associated with the one of the plurality of firmware storage partitions.

In one embodiment, there is provided a non-transitory recording medium storing a plurality of instructions which, when executed by one or more processors on an information processing apparatus, causes the processors to perform the above-described information processing method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a hardware configuration of an information processing apparatus according to an embodiment of the present disclosure;

FIG. 2 is a diagram illustrating a software configuration of the information processing apparatus according to the embodiment;

FIG. 3 is a block diagram illustrating a hardware configuration of a controller of the information processing apparatus according to the embodiment;

FIG. 4 is a functional block diagram of the controller of the information processing apparatus according to the embodiment;

FIG. 5 is a diagram illustrating a method of starting partitions in an information processing apparatus according to a comparative example;

FIG. 6A is a diagram illustrating a method of starting partitions in the information processing apparatus according to the embodiment when flag information indicates a first value;

FIG. 6B is a diagram illustrating a method of starting partitions in the information processing apparatus according to the embodiment when the flag information indicates a second value;

FIGS. 7A and 7B are tables illustrating a method of starting partitions in the information processing apparatus according to the embodiment when firmware is successfully updated;

FIGS. 8A and 8B are tables illustrating a method of starting partitions in the information processing apparatus according to the embodiment when the firmware update fails;

FIG. 9 is a flowchart illustrating operations of a first activator and a second activator in the information processing apparatus according to the embodiment;

FIG. 10 is a flowchart illustrating an operation of an update unit in the information processing apparatus according to the embodiment;

FIG. 11 is a flowchart illustrating an operation of a notification unit in the information processing apparatus according to the embodiment; and

FIG. 12 is a flowchart illustrating an information processing method according to the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Typically, an information processing apparatus selects a firmware storage partition based on boot entry information in a unified extensible firmware interface (UEFI). The firmware storage partition is an area storing a system including a bootloader and a kernel. In the startup of the information processing apparatus, the UEFI is first started. The UEFI then boots the bootloader and the kernel, for example, and the kernel starts an application. The UEFI, which is a type of software for starting an operating system (OS), functions as an interface between the OS and hardware. The UEFI initializes the hardware and starts the bootloader for the OS. The UEFI is firmware expanded as a successor to BIOS.

The information processing apparatus is therefore able to determine the firmware storage partition to start the bootloader, which is a process started by the UEFI, but is unable to select an application storage partition to start an application stored therein. In case of failure to update the firmware storage partition, therefore, recovery is limited to the firmware. Similarly, in case of failure to update the application storage partition, recovery is limited to the application.

In view of the above, the present disclosure described herein provides an information processing apparatus that recovers from both a failure to update firmware and a failure to update an application.

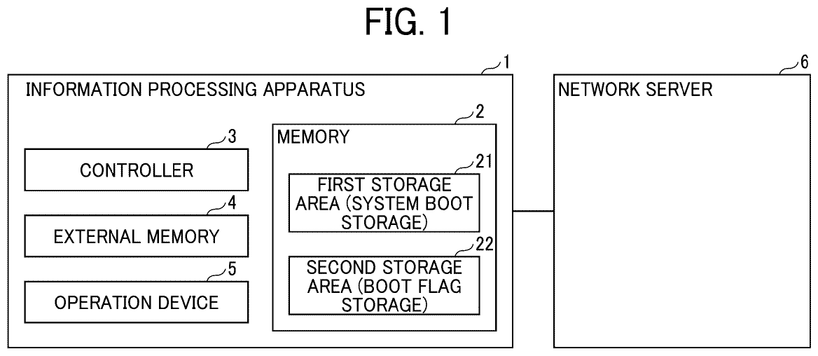

FIG. 1 is a diagram illustrating a hardware configuration of an information processing apparatus 1 according to an embodiment of the present disclosure. The information processing apparatus 1 includes a memory 2, a controller 3, an external memory 4, and an operation device 5. The information processing apparatus 1 is communicably connected to a network server 6 via network lines such as the Internet.

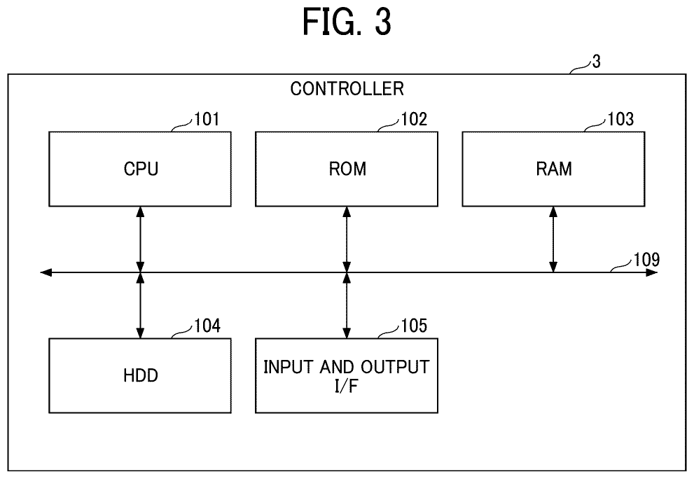

The memory 2 includes a first storage area 21 and a second storage area 22. The memory 2 is implemented by a hard disk (HD), a hard disk drive (HDD) 104, and programs executed by a central processing unit (CPU) 101 (see FIG. 3), for example.

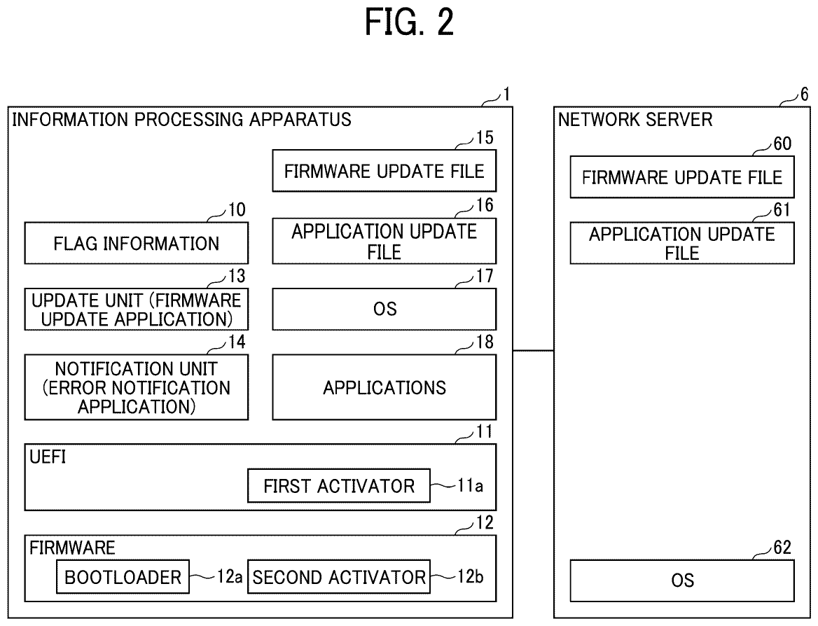

The first storage area 21 includes a plurality of firmware storage partitions each storing firmware 12 and a plurality of application storage partitions each storing an application 18 (see FIG. 2). The firmware 12 is executed at startup of the information processing apparatus 1. When one of the firmware storage partitions is started, one of the application storage partitions that is associated with the one of the firmware storage partitions is also started.

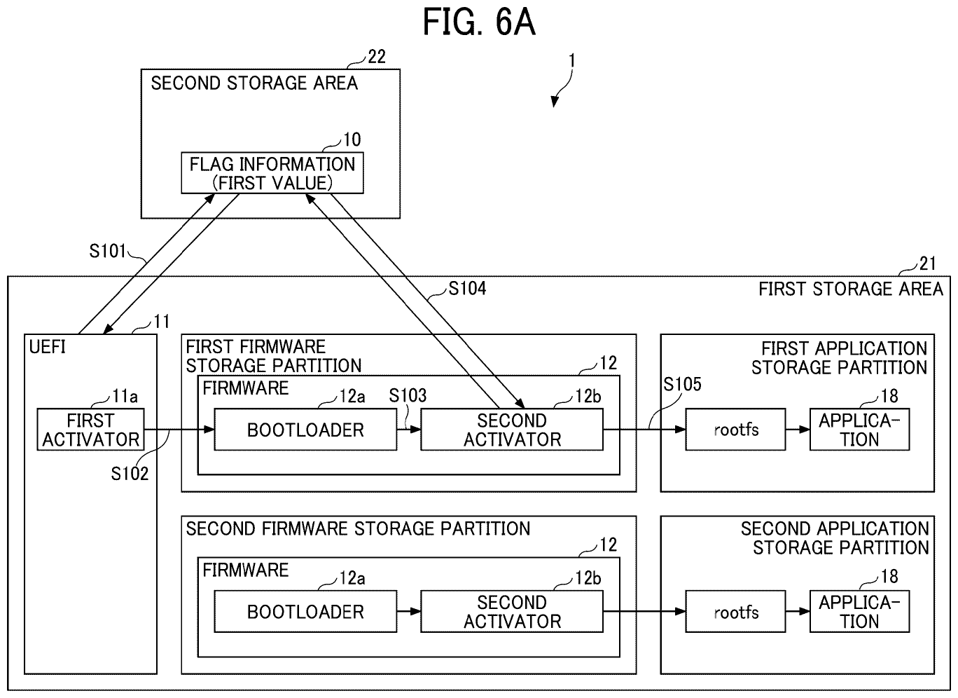

More specifically, the first storage area 21 includes a first firmware storage partition storing first firmware 12 and a second firmware storage partition storing second firmware 12 (sec FIGS. 6A and 6B). The first storage area 21 further includes a first application storage partition storing a first application 18 and a second application storage partition storing a second application 18. The first application storage partition is associated with the first firmware storage partition, and the second application storage partition is associated with the second firmware storage partition.

Hereinafter, the first firmware storage partition or the second firmware storage partition will be simply referred to as the firmware storage partition where the distinction therebetween is unnecessary. Further, the first application storage partition or the second application storage partition will be simply referred to as the application storage partition where the distinction therebetween is unnecessary. The firmware storage partition may also be referred to as the extensible firmware interface (EFI) system partition.

In the following description, it is assumed that the first firmware storage partition and the first application storage partition are associated with each other, and that the second firmware storage partition and the second application storage partition are associated with each other.

The first storage area 21 is also referred to as the system boot storage, for example. The first storage area 21 is implemented by an embedded multimedia card (eMMC™), for example.

The second storage area 22 stores flag information 10 (see FIG. 2) including information for selecting a partition to start. The second storage area 22 is also referred to as the boot flag storage, for example. The second storage area 22 may be provided in an external storage device. The second storage area 22 is implemented by a non-volatile random access memory (NVRAM), for example. The external storage device serves as a storage area used as connected to the information processing apparatus 1.

The controller 3 controls overall operation of the information processing apparatus 1. The controller 3 starts the firmware 12 in the firmware storage partition and the application 18 in the application storage partition. The controller 3 further updates the flag information 10 when the firmware 12 is successfully updated. If the update of the firmware 12 fails, the controller 3 transmits an error notification to the operation device 5.

The external memory 4 is a secure digital (SD) card, for example. The external memory 4 stores update files to newly write to the first storage area 21. The update files may be stored as compressed files.

The operation device 5 may include input means for receiving an input from a user and display means for presenting information to the user. In response to receipt of an error notification from a notification unit 14 (see FIG. 2), the operation device 5 may cause the display means to display an error message. The network server 6 stores update files to newly write to the first storage area 21.

The information processing apparatus 1 may be a projector (PJ), an interactive whiteboard (IWB) with an electronic whiteboard function enabling interactive communication, an output device such as digital signage, a head-up display (HUD), an industrial machine, an image capturing device, a sound collecting device, medical equipment, a network home appliance, a connected car, a laptop personal computer (PC), a mobile phone, a smartphone, a tablet terminal, a gaming machine, a personal digital assistant (PDA), a digital camera, a wearable PC, or a desktop PC, for example.

FIG. 2 is a diagram illustrating a software configuration of the information processing apparatus 1 according to the embodiment. The information processing apparatus 1 includes the flag information 10, a UEFI 11, the firmware 12, an update unit 13, the notification unit 14, a firmware update file 15, an application update file 16, an OS 17, and one or more applications 18 (hereinafter simply referred to as the applications 18).

The flag information 10, which includes the information for selecting the partition to start, indicates a first value or a second value. The first value and the second value may be set to, but are not limited to, 0 and 1 or 1 and 0, respectively. The flag information 10 is stored in the second storage area 22.

In the information processing apparatus 1, the UEFI 11 reads a file stored in a partition with particular specifications called “EFI system partition.” Based on the information of the read file, the UEFI 11 boots installed firmware including a bootloader and a kernel.

The UEFI 11 includes a first activator 11a. The first activator 11a is implemented by the UEFI 11, for example. If the flag information 10 indicates the first value, the first activator 11a starts the first firmware 12 stored in the first firmware storage partition. If the flag information 10 indicates the second value, the first activator 11a starts the second firmware 12 stored in the second firmware storage partition. Hereinafter, a partition to start will also be referred to as the boot partition, and a partition to update will also be referred to as the update partition.

The firmware 12 includes the bootloader 12a and the second activator 12b. The second activator 12b is a kernel, for example. The firmware 12 is included in the first firmware storage partition and the second firmware storage partition. After the firmware storage partition is started, the bootloader 12a starts the second activator 12b.

After the first activator 11a starts the firmware 12 stored in the firmware storage partition, the second activator 12b starts the application 18 stored in the application storage partition associated with the firmware storage partition based on the flag information 10.

If the flag information 10 indicates the first value, the second activator 12b starts the first application 18 stored in the first application storage partition. If the flag information 10 indicates the second value, the second activator 12b starts the second application 18 stored in the second application storage partition.

The update unit 13 is also referred to as the firmware update application, for example. The update unit 13 updates the firmware update file 15 and the application update file 16, which are targets to update. Specifically, if the firmware 12 is successfully updated, and if the flag information 10 indicates the first value, the update unit 13 updates the first value to the second value. If the flag information 10 indicates the second value, the update unit 13 updates the second value to the first value. If the update of the firmware 12 fails, the update unit 13 retains the current value of the flag information 10.

If the update unit 13 successfully updates the firmware 12, the first activator 11a starts the firmware 12 stored in the firmware storage partition based on the updated flag information 10, and the second activator 12b starts the application 18 stored in the application storage partition based on the updated flag information 10.

The notification unit 14 is also referred to as the error notification application. If the update unit 13 fails to update the firmware 12, the notification unit 14 outputs an error notification.

The firmware update file 15 and the application update file 16 are files used in the update of the firmware 12.

The OS 17 controls the entire information processing apparatus 1. The applications 18 are started and executed at system startup. Each of the applications 18 is a program executed in the corresponding application storage partition.

The firmware 12 and the applications 18 are stored in the first storage area 21. The firmware update file 15 and the application update file 16 may be stored in the external memory 4.

The network server 6 includes a firmware update file 60, an application update file 61, and an OS 62. The firmware update file 60 and the application update file 61 are downloaded by the information processing apparatus 1. The OS 62 performs overall control of the network server 6.

FIG. 3 is a block diagram illustrating a hardware configuration of the controller 3 of the information processing apparatus 1 according to the embodiment. The controller 3 includes the CPU 101, a read only memory (ROM) 102, a random access memory (RAM) 103, the HDD 104, and an input and output interface (I/F) 105, which are electrically connected to each other via a bus 109.

The CPU 101 controls the operation of the controller 3. The ROM 102 stores programs executed by the CPU 101, for example. The RAM 103 is used as a work area of the CPU 101. The HDD 104 stores various data such as programs. The input and output I/F 105 is an interface for outputting and inputting various signals and data to and from an external device.

Functions of the CPU 101 may be entirely or partially implemented by an electronic circuit such as an application specific integrated circuit (ASIC) or a field programmable gate array (FPGA).

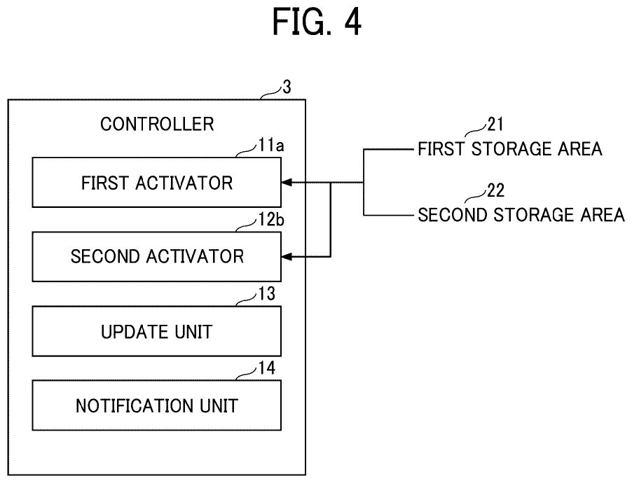

FIG. 4 is a functional block diagram of the controller 3 of the information processing apparatus 1 according to the embodiment. The controller 3 includes the first activator 11a, the second activator 12b, the update unit 13, and the notification unit 14. The first activator 11a and the second activator 12b are stored in the first storage area 21.

The first activator 11a starts the firmware 12 based on the flag information 10 stored in the second storage area 22. If the flag information 10 indicates the first value, the first activator 11a starts the first firmware 12 stored in the first firmware storage partition. If the flag information 10 indicates the second value, the first activator 11a starts the second firmware 12 stored in the second firmware storage partition.

Based on the flag information 10 in the second storage area 22, the second activator 12b starts the application 18 stored in the application storage partition associated with the started firmware storage partition.

If the flag information 10 indicates the first value, the second activator 12b starts the first application 18 stored in the first application storage partition. If the flag information 10 indicates the second value, the second activator 12b starts the second application 18 stored in the second application storage partition.

The update unit 13 updates the firmware update file 15 and the application update file 16, which are the targets to update. Specifically, if the firmware 12 is successfully updated, and if the flag information 10 indicates the first value, the update unit 13 updates the first value to the second value. If the flag information 10 indicates the second value, the update unit 13 updates the second value to the first value. If the update of the firmware 12 fails, the update unit 13 retains the current value of the flag information 10.

The notification unit 14, which is also referred to as the error notification application, transmits the error notification to the operation device 5 when the update of the firmware 12 fails.

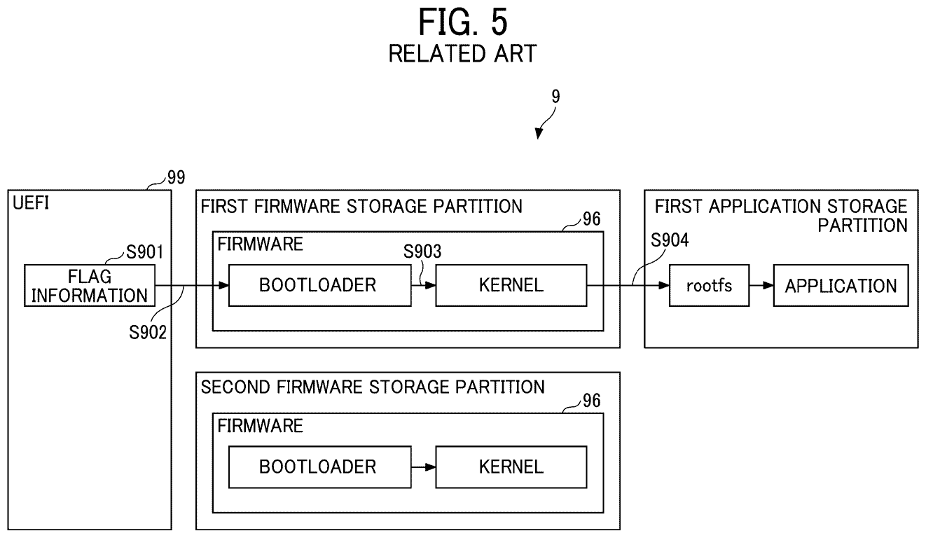

FIG. 5 is a diagram illustrating a method of starting partitions in an information processing apparatus 9 according to a comparative example. In the information processing apparatus 9 of the comparative example, firmware 96 and partitions are stored in the same storage area. The firmware 96 stores flag information. The partitions include a first firmware storage partition, a second firmware storage partition, and a first application storage partition. The first firmware storage partition and the first application storage partition are associated with each other.

In the information processing apparatus 9 of the comparative example, a UEFI 99 reads the flag information (step S901), and loads and starts the first firmware storage partition (step S902). In the first firmware storage partition, a bootloader starts a kernel (step S903). The started kernel mounts a root file system (rootfs) in the first application storage partition, and the rootfs starts an application (step S904).

According to the partition staring method performed in the information processing apparatus 9 of the comparative example, the firmware storage partition to start in a storage area is determined based on the flag information stored in the firmware 96 in the same storage area. Therefore, the firmware 96 determines the firmware storage partition to start, which limits the application storage partition to start. That is, the partition to start to start the application is not changeable.

Further, according to the partition staring method performed in the information processing apparatus 9 of the comparative example, there is no duplication of the application storage partition, while the firmware storage partitions are duplicated, i.e., two firmware storage partitions are provided. Therefore, if the first firmware storage partition fails to start due to unsuccessful update of the firmware 96, for example, the application stored in the application storage partition also fails to start.

FIG. 6A is a diagram illustrating a method of starting partitions in the information processing apparatus 1 of the embodiment when the flag information 10 indicates the first value. Herein, the first firmware storage partition and the first application storage partition are associated with each other. Further, the second firmware storage partition and the second application storage partition are associated with each other. The first activator 11a of the UEFI 11 reads the flag information 10 from the second storage area 22 and determines the firmware storage partition to start.

The UEFI 11 reads the flag information 10, which indicates the first value (step S101), and starts the firmware 12 in the first firmware storage partition (step S102). The bootloader 12a in the first firmware storage partition starts the second activator 12b (step S103). The started second activator 12b reads the flag information 10 from the second storage area 22 (step S104), and mounts a rootfs of the first application storage partition (step S105). The rootfs then starts the application 18.

FIG. 6B is a diagram illustrating a method of starting partitions in the information processing apparatus 1 of the embodiment when the flag information 10 indicates the second value. The configuration of the partitions in FIG. 6B is similar to that in FIG. 6A. Similarly as in the case in which the flag information 10 indicates the first value, the UEFI 11 reads the flag information 10 from the second storage area 22 in the external storage device, and determines the firmware storage partition to start.

Similarly as in the example of FIG. 6A, the UEFI 11 reads the flag information 10, which indicates the second value (step S201), and loads and starts the second firmware storage partition (step S202). The bootloader 12a in the second firmware storage partition starts the second activator 12b (step S203). The started second activator 12b reads the flag information 10 from the second storage area 22 (step S204), and mounts a rootfs of the second application storage partition (step S205). The rootfs then starts the application 18.

As described above with FIGS. 6A and 6B, the flag information 10 is stored in the second storage area 22, which is a separate area from the first storage area 21 storing the UEFI 11. Therefore, the second activator 12b different from the first activator 11a in the first storage area 21 is made usable. Further, the second activator 12b in the firmware storage partition reads the flag information 10 and starts the application 18 in the application storage partition associated with the firmware storage partition. Consequently, the firmware storage partition and the application storage partition start in conjunction with each other.

In case of failure to update the firmware 12 in the firmware storage partition, therefore, the information processing apparatus 1 recovers the firmware storage partition. Further, in case of failure to update the application 18 in the application storage partition, the information processing apparatus 1 recovers the application storage partition. That is, the information processing apparatus 1 is recoverable from both the failure to update the firmware storage partition and the failure to update the application storage partition, performing a recovery process with duplicated partitions to start the firmware storage partition and the application storage partition in conjunction with each other.

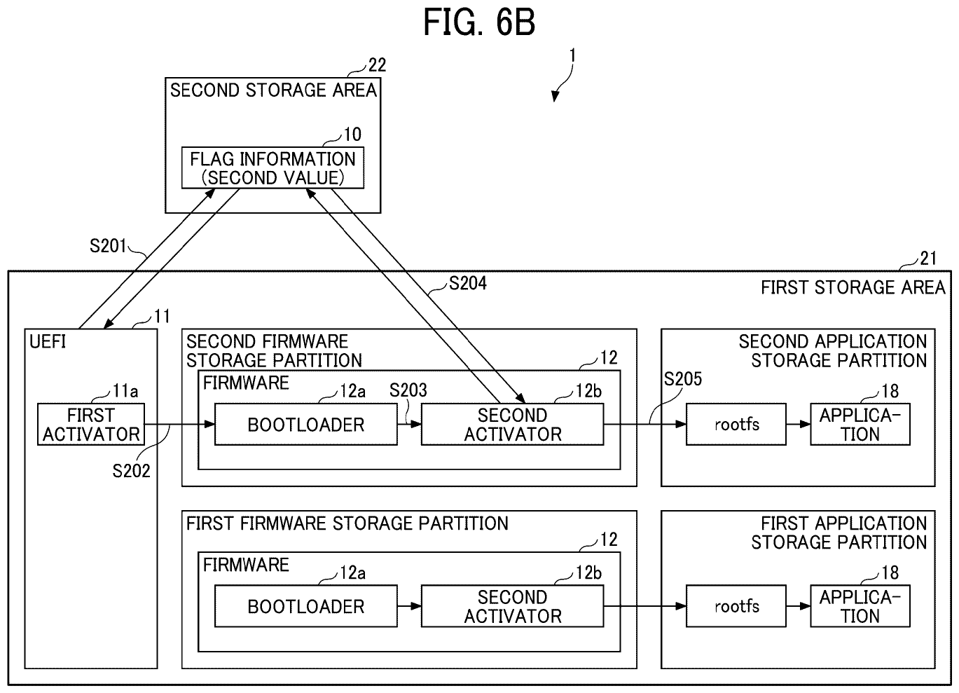

FIGS. 7A and 7B are tables illustrating a method of starting partitions in the information processing apparatus 1 of the embodiment when the firmware 12 is successfully updated. FIG. 7A illustrates a state before the update of the firmware 12, and FIG. 7B illustrates a state after the update of the firmware 12.

The example of FIGS. 7A and 7B includes path names of mount destinations to which the partitions are mounted. If the flag information 10 indicates the first value, the first firmware storage partition is a boot partition, and the application 18 in the first application storage partition is started. If the flag information 10 indicates the second value, the second firmware storage partition is a boot partition, and the application 18 in the second application storage partition is started.

In the example of FIGS. 7A and 7B, the partitions to start are mounted with names “/boot” and “/app” to allow software to handle files. In the example described below, the flag information 10 indicates the first value. In this case, the first firmware storage partition and the first application storage partition are the boot partitions. Therefore, the first firmware storage partition is mounted with the name “/boot,” and the first application storage partition is mounted with the name “/app.”

The second firmware storage partition and the second application storage partition are the update partitions. Therefore, the second firmware storage partition is mounted with a name “/boot_update,” and the second application storage partition is mounted with a name “/app_update.”

The update unit 13 updates the firmware 12 in the update partition. If the firmware 12 is successfully updated, the update unit 13 updates the flag information 10 in the boot flag storage and changes the boot partitions and the update partitions for the next startup.

A process after the restart of the system will be described.

The mount destinations of the partitions are changed, as illustrated in FIG. 7B. Specifically, the boot partitions are changed to the second firmware storage partition and the second application storage partition. Therefore, the mount destination of the second firmware storage partition is set to “/boot,” and the mount destination of the second application storage partition is set to “/app.”

Further, the update partitions are changed to the first firmware storage partition and the first application storage partition. Therefore, the mount destination of the first firmware storage partition is set to “/boot_update,” and the mount destination of the first application storage partition is set to “/app_update.”

When the system is restarted, the firmware 12 before being updated is temporarily placed in the partition with the mount destination “/boot,” and then the process switches to the update partition. Thereafter, the firmware 12 in the update partition is updated. A backup of the firmware 12 may be saved at this stage. After this process, the updated system starts normally.

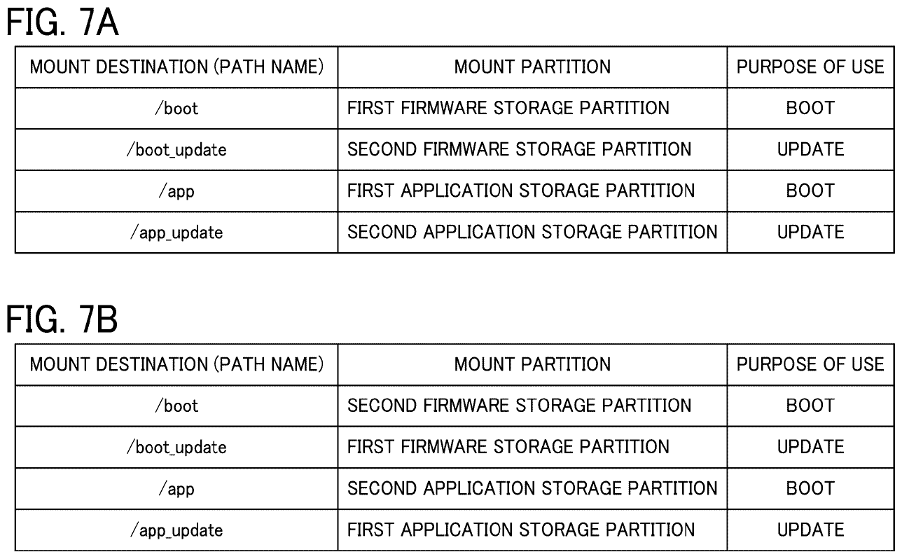

FIGS. 8A and 8B are tables illustrating a method of starting partitions in the information processing apparatus 1 of the embodiment when the update of the firmware 12 fails. FIG. 8A illustrates a state before the update of the firmware 12, and FIG. 8B illustrates a state after the update process is suspended. In the example described below, the flag information 10 indicates the first value, similarly as in the example of FIGS. 7A and 7B. The state of FIG. 8A is similar to that of FIG. 7A, in which the flag information 10 indicates the first value.

If the update unit 13 fails to update the firmware 12 in the update partition, the update unit 13 suspends the update process. As illustrated in FIG. 8B, after the suspension of the update process and the restart of the system, the mount destinations of the partitions remain the same as those used in the initial startup. If the update unit 13 fails to update the application 18 in the application storage partition, the current value of the flag information 10 is retained similarly as in the case of failure to update the firmware 12 in the firmware storage partition. Consequently, each of the firmware 12 and the application 18 starts the update process again, i.e., redoes the update process, to recover the system.

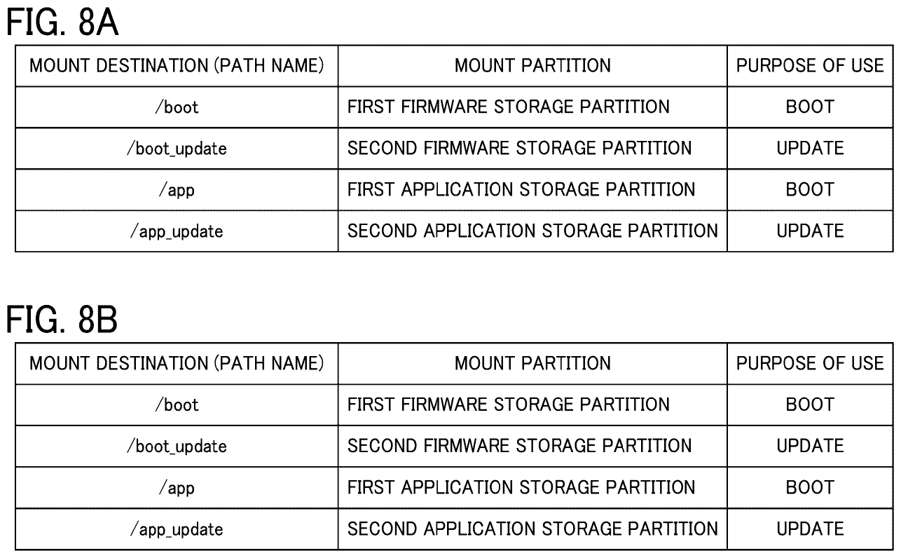

FIG. 9 is a flowchart illustrating operations of the first activator 11a and the second activator 12b in the information processing apparatus 1 of the embodiment. The first activator 11a reads the flag information 10 from the second storage area 22 (step S301). If the flag information 10 indicates the first value (YES at step S302), the first activator 11a mounts the first firmware storage partition and the first application storage partition as the boot partitions (step S303). If the flag information 10 indicates the second value (NO at step S302), the first activator 11a mounts the second firmware storage partition and the second application storage partition as the boot partitions (step S304).

At steps S101 and S102 in FIG. 6A, the mount destination of the first firmware storage partition is “/boot,” and the mount destination of the second firmware storage partition is “/boot_update.” Further, the mount destination of the first application storage partition is “/app,” and the mount destination of the second application storage partition is “/app_update.”

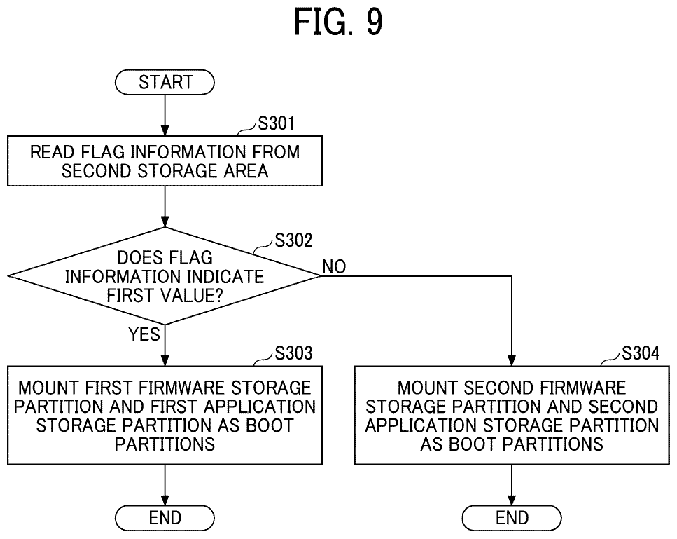

FIG. 10 is a flowchart illustrating an operation of the update unit 13 in the information processing apparatus 1 of the embodiment. The update unit 13 reads the firmware update file 15 and the application update file 16 from the external memory 4 (step S401). The update unit 13 then updates the firmware update file 15 (step S402).

If the firmware update file 15 is successfully updated (YES at step S403), the update unit 13 updates the application update file 16 (step S404). If the update of the firmware update file 15 fails (NO at step S403), the update unit 13 notifies the notification unit 14 of the occurrence of an error (step S405).

If the application update file 16 is successfully updated (YES at step S406), the update unit 13 updates the flag information 10 (step S407). If the update of the application update file 16 fails (NO at step S406), the update unit 13 notifies the notification unit 14 of the occurrence of an error (step S405).

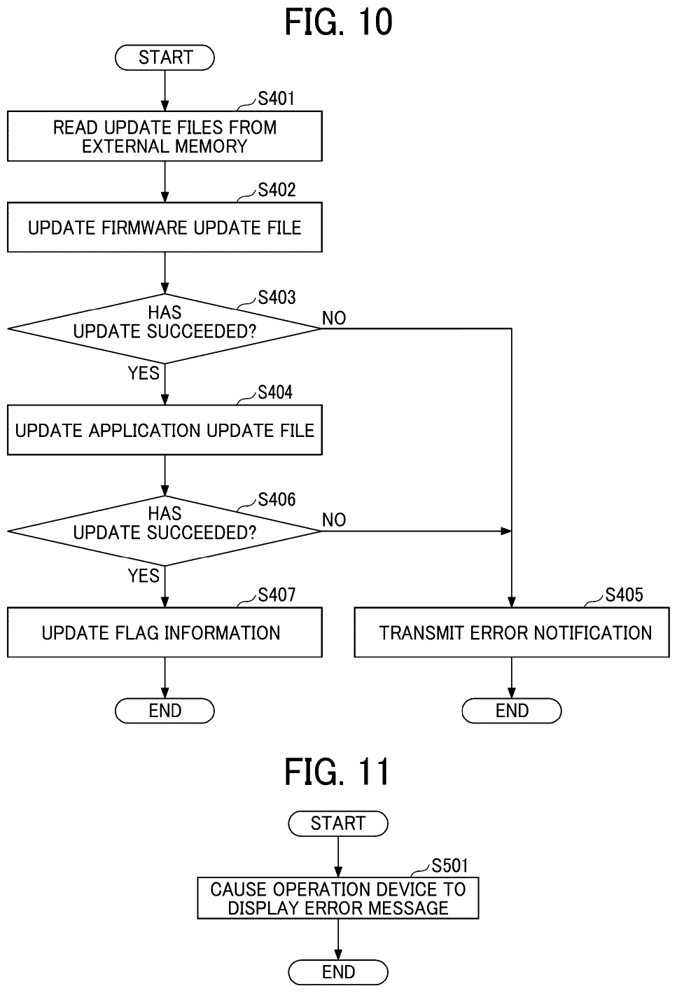

FIG. 11 is a flowchart illustrating an operation of the notification unit 14 in the information processing apparatus 1 of the embodiment. In response to receipt of the error notification from the update unit 13, the notification unit 14 transmits an error notification to the operation device 5 to cause the operation device 5 to display an error message for the user to recognize the error (step S501).

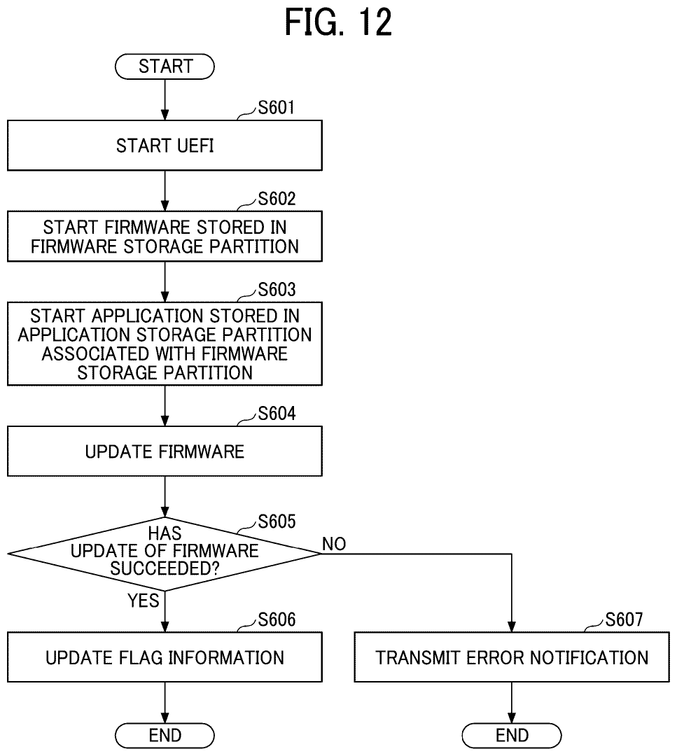

FIG. 12 is a flowchart illustrating an information processing method according to the embodiment. The information processing method is performed in the information processing apparatus 1.

The UEFI 11 is first started (step S601). Then, the first activator 11a starts the firmware 12 stored in the firmware storage partition based on the flag information 10 (step S602).

Based on the flag information 10, the second activator 12b starts the application 18 stored in the application storage partition associated with the started firmware storage partition (step S603). The update unit 13 updates the firmware 12 (step S604).

If the firmware 12 is successfully updated (YES at step S605), and if the flag information 10 indicates the first value, the update unit 13 updates the first value to the second value (step S606). If the flag information 10 indicates the second value, the update unit 13 updates the second value to the first value (step S606). If the update of the firmware 12 fails (NO at step S605), the notification unit 14 transmits an error notification to the operation device 5 (step S607).

The information processing method of the embodiment is performed with the processes of these steps. The information processing method of the embodiment may include another process as appropriate.

In the information processing apparatus 1 of the embodiment, the flag information 10 is stored in the second storage area 22, which is a separate area from the first storage area 21 storing the UEFI 11. Therefore, the second activator 12b different from the first activator 11a in the first storage area 21 is made usable. Further, the second activator 12b in the firmware storage partition reads the flag information 10 and starts the application 18 in the application storage partition associated with the firmware storage partition. Consequently, the firmware storage partition and the application storage partition start in conjunction with each other.

In case of failure to update the firmware 12 in the firmware storage partition, therefore, the information processing apparatus 1 recovers the firmware storage partition. Further, in case of failure to update the application 18 in the application storage partition, the information processing apparatus 1 recovers the application storage partition. That is, the information processing apparatus 1 is recoverable from both the failure to update the firmware storage partition and the failure to update the application storage partition, performing a recovery process with duplicated partitions to start the firmware storage partition and the application storage partition in conjunction with each other.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), digital signal processors (DSPs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The present disclosure relates to the following aspects, for example.

According to a first aspect, an information processing apparatus includes a memory, a first activator, and a second activator. The memory includes a first storage area and a second storage area. The first storage area includes a plurality of firmware storage partitions each storing firmware and a plurality of application storage partitions each storing an application. The firmware is executed at startup of the information processing apparatus. The second storage area stores flag information including information of which one of the plurality of firmware storage partitions is to be selected to start the firmware. The first activator starts the firmware stored in one of the plurality of firmware storage partitions based on the flag information. After the first activator starts the firmware stored in the one of the plurality of firmware storage partitions, the second activator starts the application stored in one of the plurality of application storage partitions based on the flag information. The one of the plurality of application storage partitions is associated with the one of the plurality of firmware storage partitions.

According to a second aspect, in the information processing apparatus of the first aspect, the plurality of firmware storage partitions in the first storage area of the memory include a first firmware storage partition storing first firmware and a second firmware storage partition storing second firmware. The plurality of application storage partitions in the first storage area of the memory include a first application storage partition storing a first application and a second application storage partition storing a second application. The first application storage partition is associated with the first firmware storage partition. The second application storage partition is associated with the second firmware storage partition. When the flag information indicates a first value, the first activator starts the first firmware stored in the first firmware storage partition, and the second activator starts the first application stored in the first application storage partition. When the flag information indicates a second value, the first activator starts the second firmware stored in the second firmware storage partition, and the second activator starts the second application stored in the second application storage partition.

According to a third aspect, the information processing apparatus of the second aspect further includes an update unit to update the firmware. When the update unit successfully updates the firmware, the update unit updates a current value of the flag information from the first value to the second value or from the second value to the first value.

According to a fourth aspect, in the information processing apparatus of the third aspect, when the update unit successfully updates the firmware, the first activator starts the firmware stored in one of the plurality of firmware storage partitions based on the updated flag information, and the second activator starts the application stored in one of the plurality of application storage partitions based on the updated flag information.

According to a fifth aspect, the information processing apparatus of the third or fourth aspect further includes a notification unit. When the update unit fails to update the firmware, the notification unit outputs an error notification.

According to a sixth aspect, in the information processing apparatus of one of the third to fifth aspects, when the update unit fails to update the firmware, the update unit retains the current value of the flag information.

According to a seventh aspect, in the information processing apparatus of one of the first to sixth aspects, the second storage area of the memory is provided in an external storage device.

According to an eighth aspect, an information processing method is performed by an information processing apparatus that includes a memory including a first storage area and a second storage area. The first storage area includes a plurality of firmware storage partitions each storing firmware and a plurality of application storage partitions each storing an application. The firmware is executed at startup of the information processing apparatus. The second storage area stores flag information including information of which one of the plurality of firmware storage partitions is to be selected to start the firmware. The information processing method includes starting the firmware stored in one of the plurality of firmware storage partitions based on the flag information, and after the start of the firmware stored in the one of the plurality of firmware storage partitions, starting the application stored in one of the plurality of application storage partitions based on the flag information. The one of the plurality of application storage partitions is associated with the one of the plurality of firmware storage partitions.

According to a ninth aspect, a non-transitory recording medium stores a plurality of instructions which, when executed by one or more processors on an information processing apparatus, cause the processors to perform an information processing method. The information processing apparatus includes a memory that includes a first storage area and a second storage area. The first storage area includes a plurality of firmware storage partitions each storing firmware and a plurality of application storage partitions each storing an application. The firmware is executed at startup of the information processing apparatus. The second storage area stores flag information including information of which one of the plurality of firmware storage partitions is to be selected to start the firmware. The information processing method includes starting the firmware stored in one of the plurality of firmware storage partitions based on the flag information, and after the start of the firmware stored in the one of the plurality of firmware storage partitions, starting the application stored in one of the plurality of application storage partitions based on the flag information. The one of the plurality of application storage partitions is associated with the one of the plurality of firmware storage partitions.

1. An information processing apparatus comprising:
a memory including
a first storage area including a plurality of firmware storage partitions each storing firmware and a plurality of application storage partitions each storing an application, the firmware being executed at startup of the information processing apparatus, and
a second storage area storing flag information including information of which one of the plurality of firmware storage partitions is to be selected to start the firmware; and
circuitry configured to execute a first activator and a second activator,
the first activator being configured to start the firmware stored in one of the plurality of firmware storage partitions based on the flag information, and
the second activator being configured to, after the first activator starts the firmware stored in the one of the plurality of firmware storage partitions, start the application stored in one of the plurality of application storage partitions based on the flag information, the one of the plurality of application storage partitions being associated with the one of the plurality of firmware storage partitions.

2. The information processing apparatus of claim 1, wherein the plurality of firmware storage partitions in the first storage area of the memory include a first firmware storage partition storing first firmware and a second firmware storage partition storing second firmware,
wherein the plurality of application storage partitions in the first storage area of the memory include a first application storage partition storing a first application and a second application storage partition storing a second application, the first application storage partition being associated with the first firmware storage partition, and the second application storage partition being associated with the second firmware storage partition,
wherein when the flag information indicates a first value, the first activator starts the first firmware stored in the first firmware storage partition, and the second activator starts the first application stored in the first application storage partition, and
wherein when the flag information indicates a second value, the first activator starts the second firmware stored in the second firmware storage partition, and the second activator starts the second application stored in the second application storage partition.

3. The information processing apparatus of claim 2, wherein the circuitry is further configured to execute an update unit to, when the firmware is successfully updated, update a current value of the flag information from the first value to the second value or from the second value to the first value.

4. The information processing apparatus of claim 3, wherein when the firmware is successfully updated, the first activator starts the firmware stored in one of the plurality of firmware storage partitions based on the updated flag information, and the second activator starts the application stored in one of the plurality of the application storage partitions based on the updated flag information.

5. The information processing apparatus of claim 3, wherein the circuitry is further configured to execute a notification unit to, when the firmware fails to be updated, output an error notification.

6. The information processing apparatus of claim 3, wherein when the firmware fails to be updated, the update unit retains the current value of the flag information.

7. The information processing apparatus of claim 1, wherein the second storage area of the memory is provided in an external storage device.

8. An information processing method performed by an information processing apparatus that includes a memory including a first storage area and a second storage area,
the first storage area including a plurality of firmware storage partitions each storing firmware and a plurality of application storage partitions each storing an application, the firmware being executed at startup of the information processing apparatus, and
the second storage area storing flag information including information of which one of the plurality of firmware storage partitions is to be selected to start the firmware, and
the information processing method comprising:
starting the firmware stored in one of the plurality of firmware storage partitions based on the flag information; and
after starting the firmware stored in the one of the plurality of firmware storage partitions, starting the application stored in one of the plurality of application storage partitions based on the flag information, the one of the plurality of application storage partitions being associated with the one of the plurality of firmware storage partitions.

9. A non-transitory recording medium storing a plurality of instructions which, when executed by one or more processors on an information processing apparatus, cause the processors to perform an information processing method,
the information processing apparatus including a memory that includes a first storage area and a second storage area,
the first storage area including a plurality of firmware storage partitions each storing firmware and a plurality of application storage partitions each storing an application, the firmware being executed at startup of the information processing apparatus, and
the second storage area storing flag information including information of which one of the plurality of firmware storage partitions is to be selected to start the firmware, and
the information processing method comprising:
starting the firmware stored in one of the plurality of firmware storage partitions based on the flag information; and
after starting the firmware stored in the one of the plurality of firmware storage partitions, starting the application stored in one of the plurality of application storage partitions based on the flag information, the one of the plurality of application storage partitions being associated with the one of the plurality of firmware storage partitions.
